(19) United States
(12) Patent Application Publication
(10) Pub. No.: US 2008/0065619 A1
(43) Pub. Date: Mar. 13, 2008

(54) METHOD, SYSTEM, AND PROGRAM PRODUCT FOR SHARING COLLABORATIVE DATA AMONG A PLURALITY OF AUTHORS

(76) Inventors: Kulvir S. Bhogal, Fort Worth, TX (US); Gregory J. Boss, American Fork, UT (US); Christopher J. Dawson, Arlington, VA (US); Rick A. Hamilton, Charlottesville, VA (US); Alexandre Polozoff, Bloomington, IL (US)

Correspondence Address: HOFFMAN, WARNICK & D'ALESSANDRO LLC, 75 STATE ST, 14TH FLOOR, ALBANY, NY, 12207, US

(21) Appl. No.: 11/470,711

(22) Filed: Sep. 7, 2006

(51) Int. Cl. G06F 17/30

(52) U.S. Cl. 707/5

(57) ABSTRACT

The invention provides a method and system for sharing collaborative data among a plurality of authors using one or a plurality of digital pens. In one embodiment, the invention includes recording information entered by a first author using a digital pen and a substrate; and recording information entered by a second author using a digital pen and a substrate, wherein recording information includes: marking a start flag; recording an identity of an author; recording information entered after the start flag; and marking a stop flag.

### FIELD OF THE INVENTION

The invention relates generally to the use of electronic authoring technologies, and more particularly, to a method, system, and program product for sharing collaborative data among a plurality of authors.

### BACKGROUND OF THE INVENTION

The use of digital (i.e., electronic) pen technologies is increasing in many fields. Such technologies allow a user to electronically store information handwritten onto a piece of paper or an electronic device, such as a tablet computer. In situations where paper is used, the digital pen typically works by optically capturing the strokes of the pen tracked against miniature dots provided on the paper's surface. These captured strokes are then translated into electronic data that may be stored in the pen itself or transferred to a computing device. Hereinafter, such paper will be referred to generally as electronic paper.

While known digital pen technologies provide great versatility and flexibility in storing information written by an individual, these technologies suffer from significant deficiencies when more than one individual contributes to the stored information. For example, when two or more individuals use the same piece of paper but different digital pens to collaboratively prepare a document, each pen stores only the information provided by its user. In a collaborative environment, this can lead to individual contributors walking away with incomplete or contradictory versions of the document.

FIGS. 1A-C show an example of information entered in such a way. FIG. 1A shows information 10 entered by a first user, as it would appear on a shared piece of paper and would be stored in the first user's digital pen. FIG. 1B shows two edits 12, 14 to information 10 made by a second user, as it would appear on the shared piece of paper. FIG. 1C, however, shows the information 20 stored in the second user's digital pen, comprising only edits 22 and 24. As can be seen in FIGS. 1A and 1C, the data stored in each user's digital pen does not accurately reflect the collaborative work of FIG. 1B.

An equally unsatisfactory result attends from each individual using the same digital pen. While the digital pen will ultimately contain all entered data and therefore accurately reflect the collaborative work, the contributions of each individual will be indistinguishable.

Accordingly, there exists a need in the art to overcome the deficiencies and limitations described hereinabove.

### SUMMARY OF THE INVENTION

The invention provides a method and system for sharing collaborative data among a plurality of authors using one or a plurality of digital pens. In one embodiment, the invention includes recording information entered by a first author using a digital pen and a substrate; and recording information entered by a second author using a digital pen and a substrate, wherein recording information includes: marking a start flag; recording an identity of an author; recording information entered after the start flag; and marking a stop flag.

A first aspect of the invention provides a method for distinguishing electronic information entered by different authors, the method comprising: recording information entered by a first author using a digital pen and a substrate; and recording information entered by a second author using a digital pen and a substrate, wherein information entered by the first author is distinguished from information entered by the second author by at least one of the following: the first author indicating that he or she has finished entering information; and the second author distinguishing himself or herself from the first author.

A second aspect of the invention provides a system for distinguishing electronic information entered by different authors, the system comprising: a system for recording information entered by a first author using a digital pen and a substrate; and a system for recording information entered by a second author using a digital pen and a substrate, wherein information entered by the first author is distinguished from information entered by the second author by at least one of the following: a system for allowing the first author to indicate that he or she has finished entering information; and a system for allowing the second author to distinguish himself or herself from the first author.

A third aspect of the invention provides a program product stored on a computer-readable medium, which when executed, distinguishes electronic information entered by different authors, the program product comprising: program code for recording information entered by a first author using a digital pen and a substrate; and program code for recording information entered by a second author using a digital pen and a substrate, wherein information entered by the first author is distinguished from information entered by the second author by at least one of the following: program code for allowing the first author to indicate that he or she has finished entering information; and program code for allowing the second author to distinguish himself or herself from the first author.

A fourth aspect of the invention provides a method for deploying an application for distinguishing electronic information entered by different authors, comprising: providing a computer infrastructure being operable to: record information entered by a first author using a digital pen and a substrate; and record information entered by a second author using a digital pen and a substrate, wherein information entered by the first author is distinguished from information entered by the second author by at least one of the following: the first author indicating that he or she has finished entering information; and the second author distinguishing himself or herself from the first author.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1A-C show steps in data entry by a plurality of authors according to an illustrative known method.

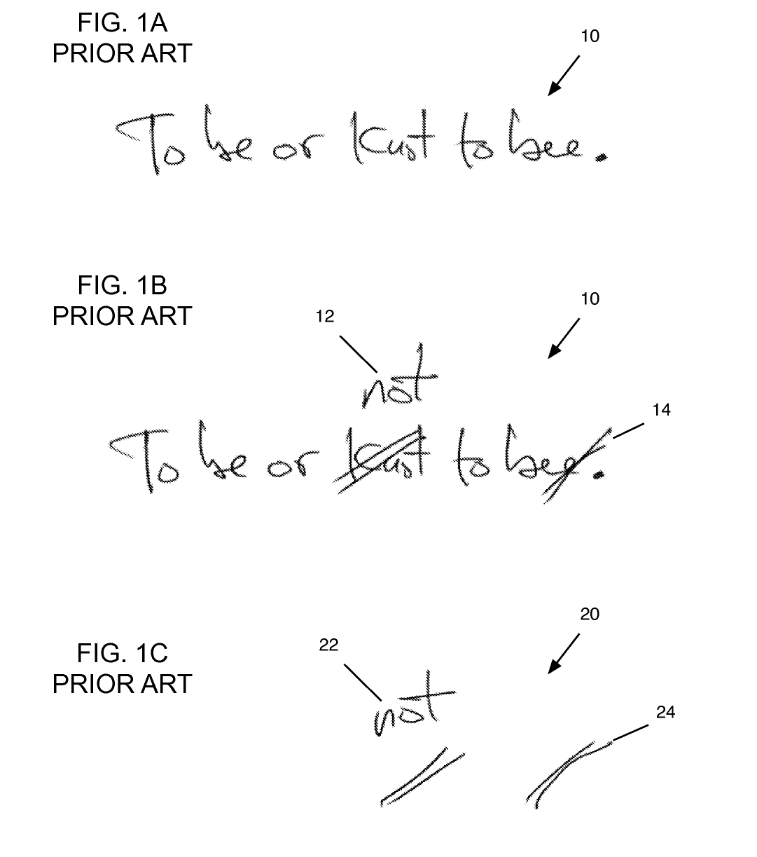

FIG. 2 shows a flow diagram of an illustrative method according to the invention.

FIG. 3 shows a block diagram of an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a method, system, and program product for sharing collaborative data among a plurality of authors using one or a plurality of digital pens. As used herein, the term “author” is defined broadly as an individual using a digital pen to enter data in any form. Accordingly, the term should not be construed as limited to an individual engaged in the creation of original works or to the entry of only text.

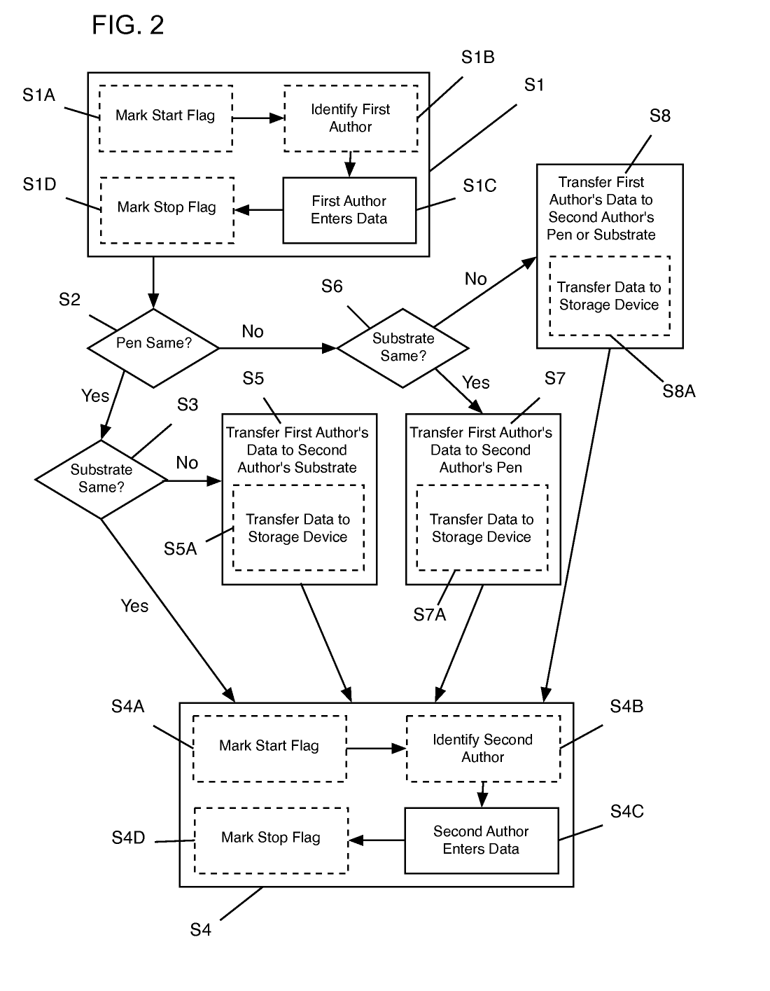

FIG. 2 shows a flow diagram of an illustrative method according to the invention. At step S1, a first author enters data using a digital pen and a substrate. As noted above, such substrates include, for example, paper, electronic paper, and tablet computers. Other suitable substrates will be recognized by one skilled in the art. Step S1 may include a number of substeps. For example, at optional steps S1A and S1B, a first author may mark a start flag and identify him/herself, respectively. Optional steps S1A and S1B may be carried out independently and in any order. A start flag may be used, for example to mark the beginning of data entered by the first author. Accordingly, the start flag may take any number of forms useful in distinguishing one author from another, such as a date/time stamp or an electronic command capable of marking the first user's data in a particular color. However, any method or mechanism of distinguishing data entered by one author from data entered by another author may be used and is within the scope of the invention.

Optional step S1B may include any method or mechanism for identifying the first author, including uniquely identifying the first author. Such methods and mechanisms include, for example, the entry of a password and the capturing of biometric data from the first author. Other methods and mechanisms for identifying an author will be recognized by one skilled in the art and are within the scope of the invention. For example, in one embodiment, optional steps S1A and S1B may be combined, whereby the marking of a start flag itself includes identifying the first author.

At step S1C, the first author enters data using a digital pen and a substrate. Once the first author has finished entering data, he/she may optionally mark a stop flag at step S1D to mark the end of data he/she has entered. The stop flag may include any method or mechanism for distinguishing data entered by one author from data entered by another author, as noted above.

At step S2, it is determined whether a second author will use the same digital pen as the first author. If so (i.e., Yes at step S2), it is then determined at step S3 whether the second author will use the same substrate (e.g., paper, electronic paper, tablet computer, etc.) as the first author. If so (i.e., Yes at step S3), a second author enters data using the same digital pen and the same digital paper at step S4. As noted above with respect to step S1, step S4 may include a number of substeps, i.e., marking a start flag at optional step S4A, identifying the second author at optional step S4B, entering data at step S4C, and marking a stop flag at optional step S4D. However, in one embodiment, if the first author has marked a stop flag at step S1D, it may be unnecessary for the second author to mark a start flag at step S4A or identify him/herself at step S4B. That is, it can be inferred from the first author's marking of a stop flag that subsequent data entry will be by a second author.

If the second author will enter data using a different substrate than the first author (i.e., No at step S3), data from the first author's substrate are transferred to the second author's substrate at step S5. Any number of known or later-developed methods or mechanisms for transferring such data may be employed, as will be recognized by one skilled in the art. Such methods and mechanisms include, for example, wireless transmission between the substrates, in the case that the substrates include tablet computers; transmission over the Internet; scanning of the first author's substrate using the second author's digital pen, where the second author's digital pen is equipped with scanning capabilities, etc. In one embodiment, at optional step S5A, data from the first author's substrate are transferred to an intermediate storage device, such as a computer, and then transferred to the second author's substrate. Once data are transferred from the first author's substrate to the second author's substrate, the second author may enter data at step S4, as described above.

If, however, the second author will enter data using a different digital pen than the first author (i.e., No at step S2), it is then determined whether the second author will use the same substrate as the first author at step S6. If so (i.e., Yes at step S6), data from the first author's digital pen are transferred to the second author's digital pen. As noted above, the transfer of data between digital pens may include any number of known or later-developed methods or mechanisms. Accordingly, in one embodiment, at optional step S7A, data from the first author's digital pen are transferred to an intermediate storage device and then transferred to the second author's digital pen. Once data are so transferred, the second author may enter data at step S4, as described above.

Finally, if the second author will use both a different digital pen and a different substrate than the first author (i.e., No at step S2 and No at step S6), data from one or both of the first author's digital pen and substrate are transferred to one or both of the second author's digital pen and substrate at step S8. In one embodiment, in order to provide redundancy and allow confirmation of transferred data, data from both the digital pen and the substrate of the first author are transferred to the digital pen and substrate of the second author. As above, such transfer may include any known or later-developed method or mechanism. Also as above, in one embodiment, at optional step S8A, data are transferred to an intermediate storage device and then transferred to one or both of the second author's digital pen and substrate. Once data are so transferred, the second author may enter data at step S4, as described above.

The method described above provides a number of significant advantages over known methods. For example, the optional steps of marking start and stop flags and identifying individual authors not only allows the contributions of each author to be distinguished when the authors use the same digital pen, but also allow the contributions of individual authors to be separately displayed (e.g., the contributions of each author being alternately hidden and revealed), in the case that all data are transferred to a single device or computer program. In addition, the transfer of data between the digital pens and/or substrates of a plurality of authors ensures that each author has access to all data entered by all authors. While the method of the present invention has been described as including a first and second author, it should be recognized that the method may be employed for any number of authors.

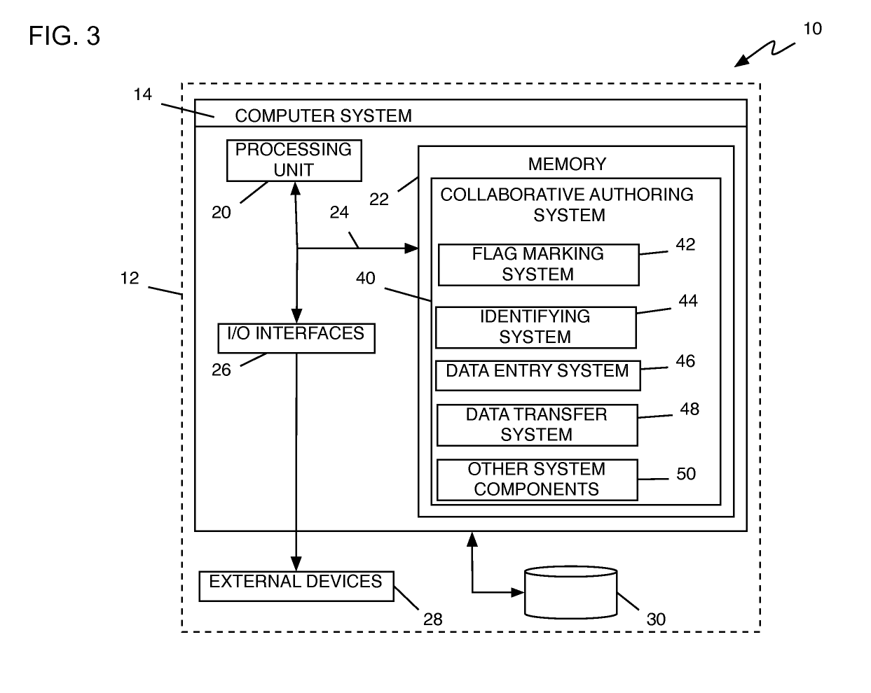

FIG. 3 shows an illustrative system 10 for sharing collaborative data among a plurality of authors. To this extent, system 10 includes a computer infrastructure 12 that can perform the various process steps described herein for sharing collaborative data among a plurality of authors. In particular, computer infrastructure 12 is shown including a computer system 14 that comprises a collaborative authoring system 40, which enables computer system 14 to share collaborative data among a plurality of authors by performing the process steps of the invention.

Computer system 14 is shown including a processing unit 20, a memory 22, an input/output (I/O) interface 26, and a bus 24. Further, computer system 14 is shown in communication with external devices 28 and a storage system 30. As is known in the art, in general, processing unit 20 executes computer program code, such as collaborative authoring system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and collaborative authoring system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, collaborative authoring system 40 enables computer system 14 to share collaborative data among a plurality of authors. To this extent, collaborative authoring system 40 is shown including a flag marking system 42, an identifying system 44, a data entry system 46, and a data transfer system 48. Operation of each of these systems is discussed above. Collaborative authoring system 40 may further include other system components 50 to provide additional or improved functionality to collaborative authoring system 40. It is understood that some of the various systems shown in FIG. 3 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for sharing collaborative data among a plurality of authors, it is understood that the invention further provides various alternative embodiments. For example, in one embodiment, the invention provides a computer-readable medium that includes computer program code to enable a computer infrastructure to share collaborative data among a plurality of authors. To this extent, the computer-readable medium includes program code, such as collaborative authoring system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to share collaborative data among a plurality of authors as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for sharing collaborative data among a plurality of authors. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for distinguishing electronic information entered by different authors, the method comprising:
recording information entered by a first author using a digital pen and a substrate; and
recording information entered by a second author using a digital pen and a substrate,
wherein information entered by the first author is distinguished from information entered by the second author by at least one of the following:
the first author indicating that he or she has finished entering information; and
the second author distinguishing himself or herself from the first author.

2. The method of claim 1, wherein the substrate is selected from a group consisting of: paper, electronic paper, a liquid crystal display (LCD), and a tablet computer.

3. The method of claim 1, wherein recording information includes:
marking a start flag;
recording an identity of an author;
recording information entered after the start flag; and
marking a stop flag.

4. The method of claim 1, further comprising:
uniquely identifying at least one of the first author and the second author.

5. The method of claim 1, wherein at least one of the digital pen and the substrate used by the second author is different than the digital pen and the substrate used by the first author.

6. The method of claim 5, further comprising:
transferring from the digital pen used by the first author to the digital pen used by the second author, the information entered by the first author, in the case that the first author and the second author use the same substrate and different digital pens.

7. The method of claim 6, wherein transferring includes:
transferring to a storage device the information entered by the first author; and
transferring from the storage device to the digital pen of the second author the information entered by the first author.

8. The method of claim 5, further comprising:
transferring to a substrate used by the second author the information entered by the first author, in the case that the first author and the second author use different substrates and the same digital pen.

9. A system for distinguishing electronic information entered by different authors, the system comprising:
a system for recording information entered by a first author using a digital pen and a substrate; and
a system for recording information entered by a second author using a digital pen and a substrate,
wherein information entered by the first author is distinguished from information entered by the second author by at least one of the following:
a system for allowing the first author to indicate that he or she has finished entering information; and
a system for allowing the second author to distinguish himself or herself from the first author.

10. The system of claim 9, wherein the system for recording information includes:
a system for marking a start flag;
a system for recording an identity of an author;
a system for recording information entered after the start flag; and
a system for marking a stop flag.

11. The system of claim 9, wherein at least one of the digital pen and the substrate used by the second author is different than the digital pen and the substrate used by the first author.

12. The system of claim 11, further comprising:
a system for transferring from the digital pen used by the first author to the digital pen used by the second author, the information entered by the first author, in the case that the first author and the second author use the same substrate and different digital pens.

13. The system of claim 12, wherein the system for transferring includes:
a system for transferring to a storage device the information entered by the first author; and
a system for transferring from the storage device to the digital pen of the second author the information entered by the first author.

14. The system of claim 11, further comprising:
a system for transferring to a substrate used by the second author the information entered by the first author, in the case that the first author and the second author use different substrates and the same digital pen.

15. A program product stored on a computer-readable medium, which when executed, distinguishes electronic information entered by different authors, the program product comprising:
program code for recording information entered by a first author using a digital pen and a substrate; and
program code for recording information entered by a second author using a digital pen and a substrate,
wherein information entered by the first author is distinguished from information entered by the second author by at least one of the following:
program code for allowing the first author to indicate that he or she has finished entering information; and
program code for allowing the second author to distinguish himself or herself from the first author.

16. The program product of claim 15, wherein the program code for recording information includes:
program code for marking a start flag;
program code for recording an identity of an author;
program code for recording information entered after the start flag; and
program code for marking a stop flag.

17. The program product of claim 15, wherein at least one of the digital pen and the substrate used by the second author is different than the digital pen and the substrate used by the first author.

18. The program product of claim 17, further comprising:
program code for transferring from the digital pen used by the first author to the digital pen used by the second author, the information entered by the first author, in the case that the first author and the second author use the same substrate and different digital pens.

19. The program product of claim 18, wherein the program code for transferring includes:
program code for transferring to a storage device the information entered by the first author; and
program code for transferring from the storage device to the digital pen of the second author the information entered by the first author.

20. The program product of claim 17, further comprising:
program code for transferring to a substrate used by the second author the information entered by the first author, in the case that the first author and the second author use different substrates and the same digital pen.

21. A method for deploying an application for distinguishing electronic information entered by different authors, comprising:
providing a computer infrastructure being operable to:
record information entered by a first author using a digital pen and a substrate; and
record information entered by a second author using a digital pen and a substrate,
wherein information entered by the first author is distinguished from information entered by the second author by at least one of the following:
the first author indicating that he or she has finished entering information; and
the second author distinguishing himself or herself from the first author.
